(19) United States
(12) Patent Application Publication
(10) Pub. No.: US 2002/0125256 A1
(43) Pub. Date: Sep. 12, 2002

(54) Hinge lid closure system for containers

(76) Inventors: Maria T. Sack, Kaaawa, HI (US); Matthew T. Sack, Kaaawa, HI (US)

Correspondence Address: MARIA T. SACK, P.O. Box 229, Kaaawa, HI, 96730, US

(21) Appl. No.: 09/802,023

(22) Filed: Mar. 9, 2001

(51) Int. Cl. A47G 19/02; A47J 36/06

(52) U.S. Cl. 220/574.1; 220/324; 220/847; 220/912; 220/735

(57) ABSTRACT

A hinge lid for a food container is provided, which is adapted to fasten over the rim or lip of any different size and shape containers at a point(s) by means of a clamp, and includes a flip-open section, which allow easy quick repeated opening and closing with one hand. The edge of the flip-open section may contain a small open section to anchor a serving utensil.

### BACKGROUND OF THE INVENTION

1. Field of the Invention

The present invention relates to a hinge lid closure system for food containers, specifically to such closures which are used for covering food during pinics.

2. Description of the Related Art

Users of containers, and, in particular users of food containers for outdoor picnics have searched for a closure system that is easy to use while still adequately keep flies, insects, and debris from food. At picnics, conventional food lids and/or aluminum foil are used to cover the food container to keep flies and insects away. These closures are difficult to manipulate, often requires both hands to open and/or close. Therefore, it would be helpful to such users to have a reliable closure system that can adapt to any of the current food containers, and can be operated with one hand.

In addition, a user often need to lift the conventional lids and/or aluminum foil to determine the food content inside which leads to unwanted excess handling of the food.

Still further, the usage of aluminum foil as closure during a picnic is not adequate to handle numerous repetitive use as is typical of picnic setting. The aluminum foil requires both hands to seal the food properly, and is suceptiable to tearing.

Thus, a need exists for an improved container closure system addressing one or more of the above-noted problems.

### DRAWING FIGURES

FIGS. 1, 3, and 4 are top views of the hinge lids.

FIG. 2 is a side view of the lid of FIG. 1 fastened to the rim of a container showing the lid in a semi open position.

### RERENCE NUMERALS IN DRAWINGS

1 hinge lid

2 slit openings

3 pilot line

4 body portion of the hinge lid

5 small opening for utensil

6 flip-open portion of the hinge lid

8 lift tab

9 clamp

10 food container

### BEST MODE FOR CARRYING OUT THE INVENTION

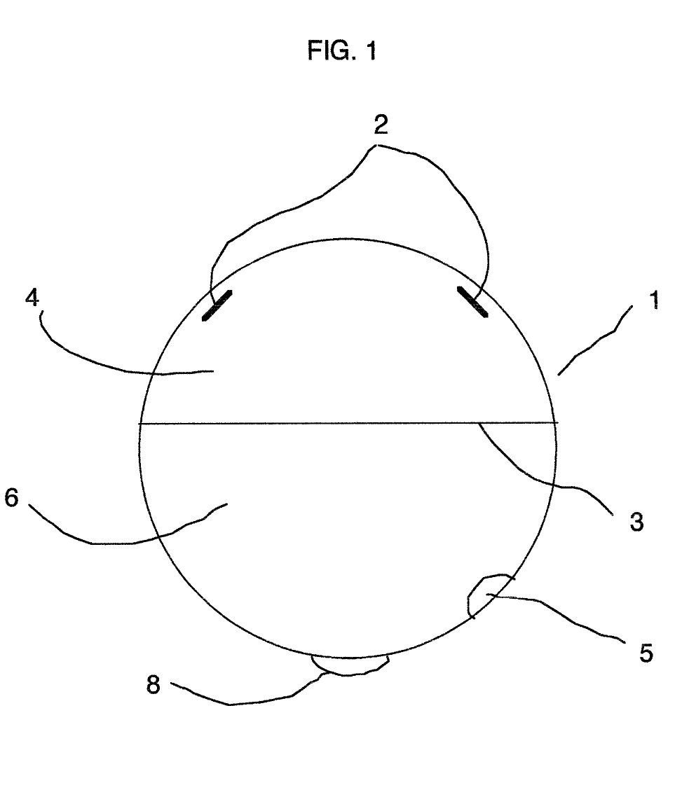

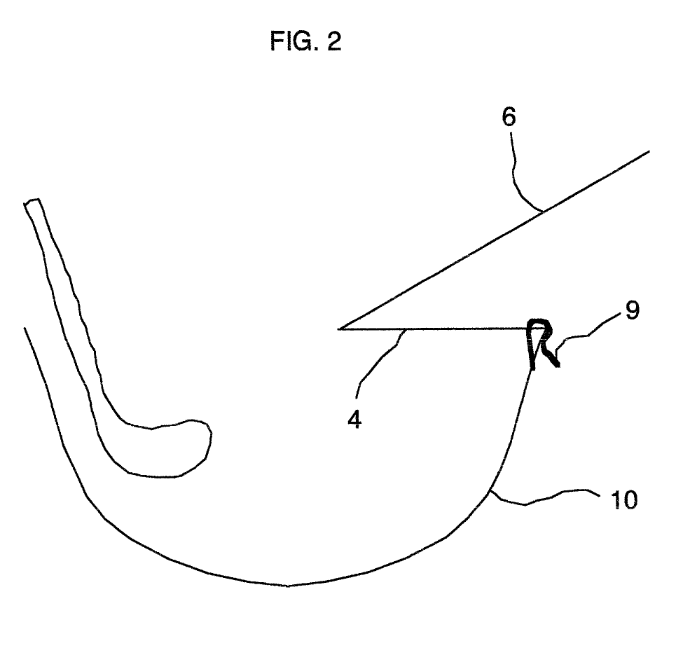

Referring to the drawings, wherein like numerals represent like parts in the several views, in FIG. 1 the numeral 1 represents a hinge lid that can be produced in various sizes and shapes to cover any size food container, which include a body portion 4 and a flip-open section 6. The body portion 4 comprise of small slit openings 2 to allow clamps 9 in FIG. 2 to anchor the lid on to the rim of any size food container. The flip-open section 6 is pivoted along 3 to form an opening in the lid. The flip-open section 6 includes a tab 8 to facilitate lifting of the flip-open section 6. The pivot line 3 can be made of any conventional hinge mechanism, or it can be scored to allow the flip-open section 6 to bend back. The flip-open section 6 also includes a small opening 5 at a peripheral edge to anchor a serving utensil.

FIG. 2 depicts the side view of the lid 1 secure to the food container 10 by clamps 9. The lid 1 is shown in a semi opened position with the flip-open section 6 flipped back to allow easy access to the food. The flip-open section 6 can be flipped closed again to keep flies and insects away from the food.

The lid of the invention may be formed of any conventional lid material, such as plastics, paper board, cardboard and the like. The clamps of the invention may be formed of any conventional clamp material, such as plastic, rubber, metal and the like.

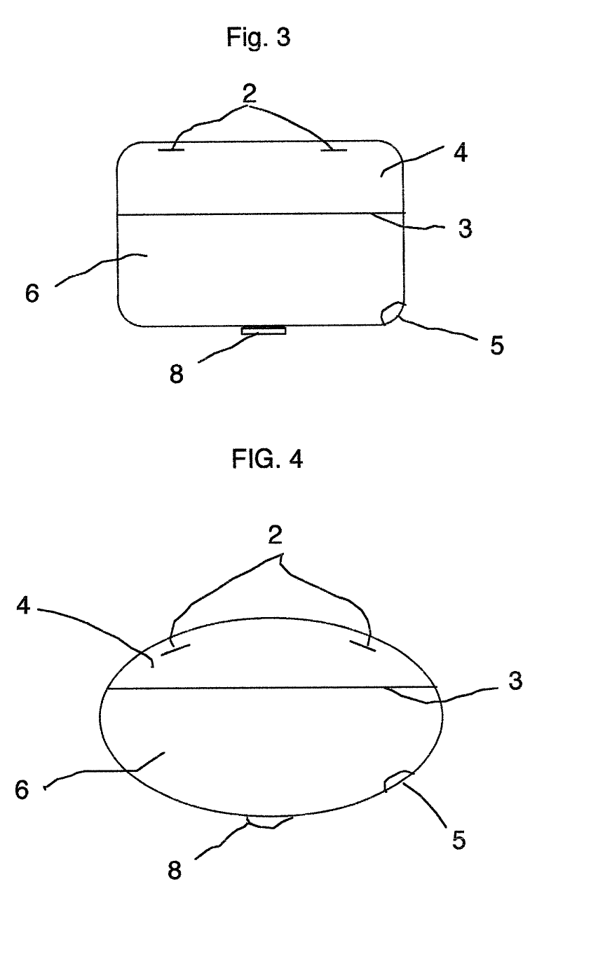

FIG. 3 and 4 depicts the top views of the different shape of lids that the present invention provides.

While several aspects of the invention have been described and depicted herein, alternative aspects may be effected by those skilled in the art to accomplish the same objectives. According, it is intended by the appended claims to cover all such alternative aspects as fall within the true spirit and scope of the invention.

### SUMMARY OF THE INVENTION

Briefly, the present invention satisfies the need for an improved container closure system by providing various sizes and shapes hinge lids with, among other things, a clamp device that is adapted to clip on to all different size and shape containers, a hinge to allow quick easy opening and closing of the flip-open section with one hand, a small opening at the edge of the flip-open section to anchor a serving utensil.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A reusable hinged lid adapted to fit on the rim of a food container.

2. The lid of claim 1 wherein said lid comprising a said body portion including said slit openings to allow said clamps to secure said lid on the rim of a food container.

3. The lid of claim 1 wherein said body has a flip-open section being adapted to be repeatedly opened or closed to seal said container by pivoting said flip-open section about said pivot.

4. The lid of claim 1 wherein said body has a small opening at a peripheral edge of said flip-open section for anchoring a serving utensil.
